(19) United States
(12) Patent Application Publication
(10) Pub. No.: US 2026/0371071 A1
(43) Pub. Date: Nov. 19, 2026

(54) VIRTUAL MOBILE NUMBERS FOR ENHANCING PRIVACY IN DIGITAL INTERACTIONS

(71) Applicant: PAYPAL, INC., San Jose, CA (US)

(72) Inventors: Mounika Gampa, Santa Clara, CA (US); Sujan Reddy Annem, San Jose, CA (US); Gopiharis Velraj, San Jose, CA (US)

(21) Appl. No.: 19/392,578

(22) Filed: Nov. 18, 2025

Related U.S. Application Data
(60) Provisional application No. 63/807,351, filed on May 16, 2025.

(51) Int. Cl. H04W 12/02; G06Q 20/38; H04M 3/42

(52) U.S. Cl. CPC H04W 12/02; G06Q 20/383; H04M 3/42008

(57) ABSTRACT

Sharing identifiers, such as phone numbers, for interactions, such as payment, can unintentionally expose sensitive personal information, including full names and addresses, through platform-linked identity data. Disclosed herein is a centralized framework for virtual mobile numbers (VMNs) based privacy preserving interactions. VMNs are pseudonymous public identifiers that can be mapped to real identifiers through a secure resolver.

### CROSS REFERENCE TO RELATED APPLICATIONS

The present disclosure claims priority to U.S. Provisional Application 63/807,351, filed on May 16, 2025, and entitled “VIRTUAL MOBILE NUMBERS FOR ENHANCING PRIVACY IN DIGITAL INTERACTIONS”, which is incorporated by reference in its entirety.

### TECHNICAL FIELD

The present disclosure relates to privacy and, more particularly, to virtual identifiers in digital interactions.

### BACKGROUND

Digital interactions include the exchange between user devices (e.g., smartphones) of information such as text messages, photos, videos, and payments. Little stands in the way of digital interactions as they can take place at nearly any location and between nearly any device. For example, mobile payment platforms make peer-to-peer transfers fast and easy, often just needing a phone number to get started.

### BRIEF DESCRIPTION OF THE DRAWINGS

Certain features of the subject technology are set forth in the appended claims. However, for the purpose of explanation, several embodiments of the subject technology are set forth in the following figures, where like reference numerals refer to the same or similar features in the various figures.

FIG. 1 is a block diagram of an example system, in accordance with one or more embodiments.

FIG. 2 is a sequence diagram of example virtual identifier operations, in accordance with one or more embodiments.

FIG. 3 is a flow diagram of an example process for generating and/or resolving virtual identifiers, in accordance with one or more embodiments.

FIG. 4 is a flow diagram of an example process for deactivating and/or updating virtual identifiers, in accordance with one or more embodiments.

FIG. 5 is a flow diagram of an example process for requesting and using virtual identifiers, in accordance with one or more embodiments.

FIG. 6 is a block diagram of an example computing system, in accordance with one or more embodiments.

### DETAILED DESCRIPTION

Digital interactions enable near frictionless exchanges of information, such as text, images, and payments. While digital interactions enable unmatched convenience and speed, they may also introduce privacy and security concerns. For example, in scenarios where users engage in informal buying and selling, such as online marketplaces, transaction legitimacy and user anonymity can be exploited. Exploitation may occur through the sharing of phone numbers (or other identifier associated with a user) to facilitate digital interactions (e.g., payments). A user’s phone number may be linked to a variety of other information about the user, such as their social media profiles that may include real names, addresses, relatives, employer, or payment information. With the linked information exposed, the information can be used to make unauthorized use of the user’s identity, e.g., to access accounts, make purchases, and/or the like.

Sharing of a phone number (or other identifier) to online platforms that facilitate digital interactions may also be exploited. For example, once a phone number is linked to a digital profile, it may become a valuable data point for marketers and data brokers. That connection can be used for targeted advertising campaigns or sold to third parties, potentially resulting in unwanted texts, emails, calls, or other contact.

To help address these privacy concerns, this disclosure introduces virtual identifiers, also referred to herein as virtual mobile numbers (VMNs). Virtual identifiers are identifiers that create a protective layer between a user’s real identifier and an online platform so that the user’s real identifier stays hidden during interactions. The VMN system may be based on a centralized and secure approach to mapping virtual identifiers to real identifiers so that users’ real identifiers remain confidential during interactions. Real identifiers may include phone numbers, user names, and/or any other identifier associated with a user, which may be unique to an online platform. virtual identifiers may also include phone numbers, user names, and/or any other information that may become associated with a user to proxy the user’s real identifier. Online platforms may include payment systems, communication platforms, social media, and/or any other platform with accounts associated with a user. Interactions may include transactions, messaging, and/or any other form of information exchange between users facilitated at least in part by an online platform.

The VMN system integrates with existing digital interaction tools and services. Instead of replacing current systems, the VMN system works alongside them to provide an additional layer of privacy and security. The VMN system enables users to create temporary, disposable identifiers tied to a real identifier further enabling users to control when and how their real identifiers are shared. To help prevent misuse, the VMN system may include safeguards such as limiting each user to a pre-determined number (e.g., one) of active virtual identifiers at a time. These safeguards ensure that users can benefit from added protection without compromising usability.

The system also follows the data minimization principle of the General Data Protection Regulation (GDPR), ensuring that real identifiers are not exposed to unauthorized third parties.

Only the necessary party (e.g., the payments platform conducting the transaction) can resolve the virtual identifier to the real identifier. Once the digital interaction (e.g., transaction) is complete, the user’s identity remains concealed, thus mitigating the risk of identity theft, spam, or fraud.

In addition, access to the system may be limited to verified service providers, which have undergone proper authentication and regulatory compliance checks. These platforms may be permitted to query the centralized resolver only during certain actions, such as the actual settlement phase of a transaction. Even then, the system ensures that the real phone number behind a virtual identifier is only revealed after the action (e.g., transaction) is initiated and verified through secure channels. This protects the user’s real identity from being exposed to the recipient, merchants, or any third-party services involved in the digital interaction.

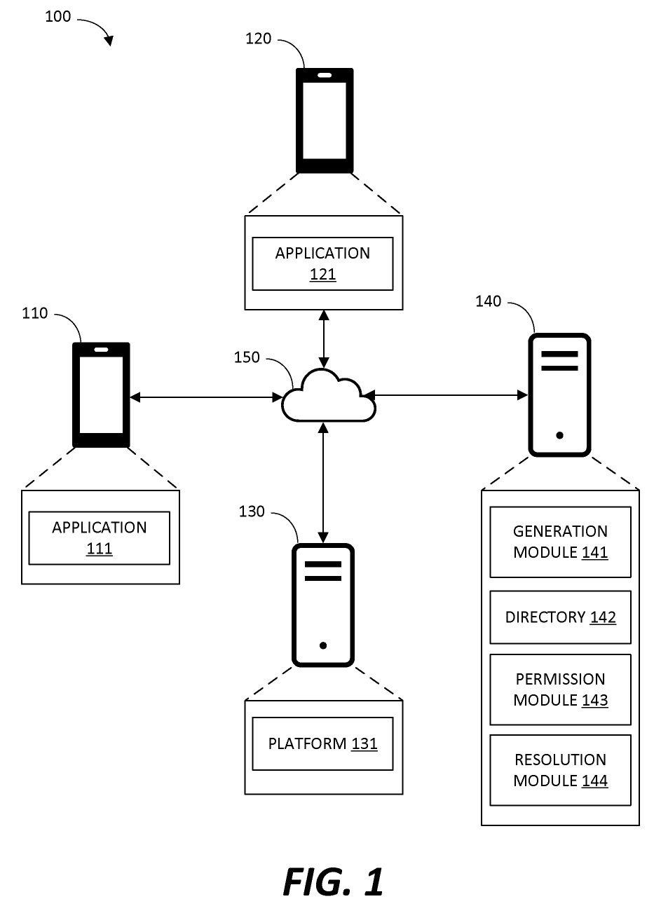

Referring now to the drawings, wherein like numerals refer to the same or similar features in the various figures, FIG. 1 is a block diagram of an example system 100, in accordance with one or more embodiments. Not all of the depicted components may be used in all embodiments, and one or more embodiments may include additional, fewer, or different components than those shown in the figure. Variations in the arrangement and type of components may be made without departing from the spirit or scope of the claims as set forth herein. Furthermore, the modules described with respect to the system 100 are used for convenience to refer to functionality that the system 100 is configured to perform by way of one or more components of the system 100 (e.g., computer-readable instructions in memory).

The system 100 may include one or more user devices 110, 120, which may each include applications 111, 121. The application 111 may be any suitable application, such as a mobile payment application, a social media application, and/or the like, that works in coordination with a platform 131. Within the application 111, the user may have the option to generate a new VMN, view one or more of their current VMNs, refresh one or more of their current VMNs, and/or discard one or more of their current VMNs. The user may store one or more of their VMNs on the user device 110 and exchange one or more of their VMNs with other users (e.g., user device 120) with whom they want to interact (e.g., via the user device 110).

The system 100 may also include a platform device 130, and the platform device 130 may include a platform 131. The platform 131 may be any hardware device and/or software application that intermediates, manages, or otherwise facilitates exchanges between users, e.g., by providing a structured environment for transactions, communications, or other digital interaction. The platform 131 may include payment systems, communication platforms, social media, and/or any other platform with accounts associated with a user. In the context of virtual identifiers, a platform 131 may be an entity authorized to query a centralized resolver to map virtual identifiers to real identifiers for the purpose of completing a digital interaction.

The system 100 may also include a VMN device 140, and the VMN device 140 may include a generation module 141, directory 142, permission module 143, and resolution module 144.

The generation module 141 may include an API (application programming interface). The user device 110 may request the generation module 141 to generate VMN. The VMN may be associated with the user’s real identifier (e.g., phone number), and access to the VMN and its association may be limited to the user or certain pre-authorized online platforms. The generation module 141 ensures that each VMN is unique and available at the time of generation by conducting duplicate checks in real-time against a directory 142. If the generated VMN is already in use or otherwise not available, the generation module 141 may automatically generate another VMN, check for uniqueness and availability, and continue this process until a VMN is successfully generated.

To ensure there are enough numbers available for all users, the generation module 141 includes a pool of virtual number ranges. The generation module 141 avoids overlap in the generation process by maintaining (e.g., on the directory 142) a one-to-one mapping of real identifiers (e.g., phone numbers) and virtual identifiers (e.g., VMN). Furthermore, the generation module 141 may check for number exhaustion and verify that enough VMNs are available for continuous use.

The directory 142 may map each VMN to a real identifier (e.g., phone number). The connection may happen within a secure and trusted system so the user’s real identifier is not visible to the user with whom they are interacting (e.g., receiving a payment). The user’s real identifier may be used privately to facilitate the interaction (e.g., complete the payment) by sharing the real identifier with certain pre-authorized online platforms but not other users. By handling VMN resolution internally, the directory 142 helps protect users from unnecessary exposure of their real identifier thus keeping their personal information safe.

The permission module 143 may manage access control and authorization. The permission module 143 may enforce an access control policy that defines the criteria for authorizing platform devices, such as the platform device 130, to access the VMN device 140. When a platform device 130 sends a request to resolve a virtual identifier to a real identifier, the permission module 143 evaluates the request against the access control policy. This evaluation may include verifying the identity of the platform device 130, checking for valid authentication credentials, and ensuring compliance with predetermined requirements (e.g., contractual requirements).

The resolution module 144 may include an API for utilization by pre-authorized applications, such as application 111. During an interaction (e.g., transaction), the application 111 queries the directory 142 via the resolution module 144 using the recipient’s virtual identifier to retrieve the corresponding real identifier (e.g., for transaction purposes).

The resolution module 144 may handle the VMN resolution process. The resolution module 144 maps a given VMN to its corresponding the real identifier without exposing the user’s real identifier to the requester. The resolution module 144 ensures that after resolution, the real identifier is used for backend operations (e.g., transaction settlement), minimizing exposure risks.

In operation, the system 100 uses VMNs to make digital interactions (e.g., mobile payments) more private and secure. The system 100 may generate users a VMN that acts like a proxy for their real identifier (e.g., phone number) during digital interactions (e.g., transactions). This enables users to, for example, send or receive payments without ever revealing their real identifier to others, giving them an extra layer of protection and keeping their identity more private. To ensure that each VMN is unique and available, the VMN device 140 may perform real-time availability checks when generating the VMN. When a user requests a new VMN, the system 100 queries a centralized directory for a VMN that has not already been assigned. Additionally or alternatively, when a user requests a new VMN and the requested VMN is unavailable, the VMN device 140 may generate a unique VMN and check the directory 142 for availability before assigning the VMN to the user (e.g., mapped to the user’s real identifier). This check ensures that there are no conflicts or duplicates, enabling smooth and secure interactions.

Users may have complete control over their VMNs. They can generate a new VMN when needed, refresh an existing VMN (e.g., replace an existing VMN with a new VMN) if they want to keep using it, or simply delete an existing VMN altogether (e.g., delete the mapping between VMN and real identifier). In some embodiments, to improve manageability, each user may only have one active VMN at a time.

Access to the system 100 that maps VMNs to real identifiers may be limited to authorized platforms (e.g., payment service providers), which may have undergone proper authentication and approval processes. In some embodiments, these platforms can only query (e.g., via the resolution module 144) the centralized resolver (e.g., the resolution module 144) to facilitate a digital interaction, such as during the real settlement phase of a transaction. This may help protect the user’s real identity from being exposed to, for example, the recipient, merchants, or any other third-party services involved in the interaction.

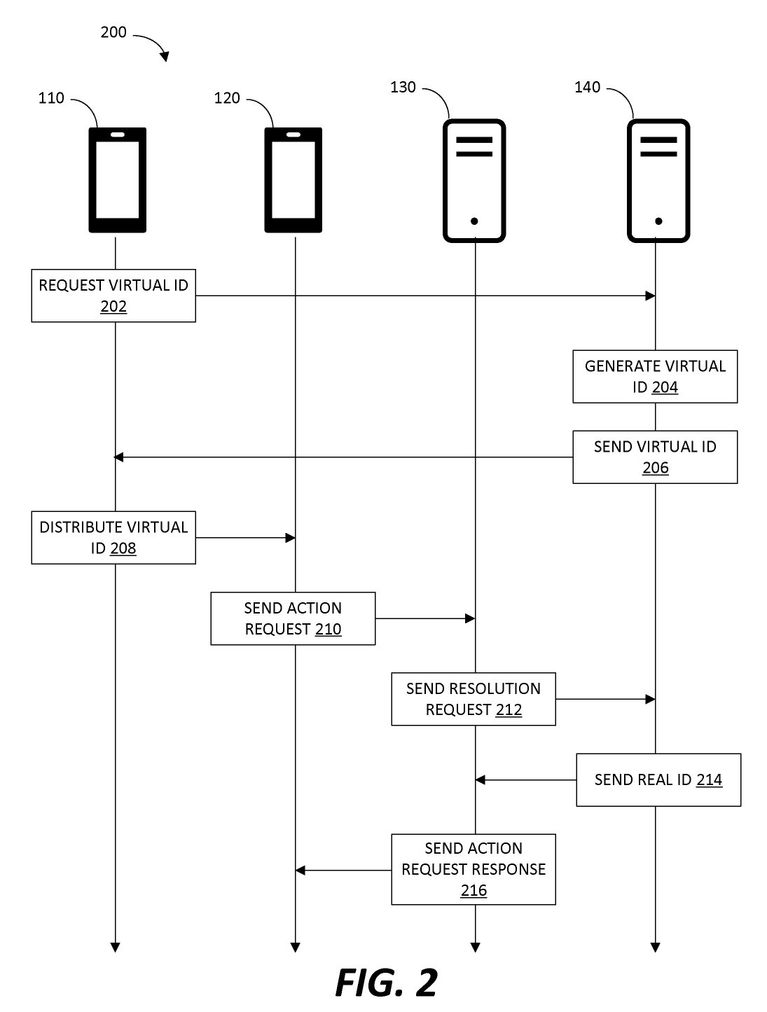

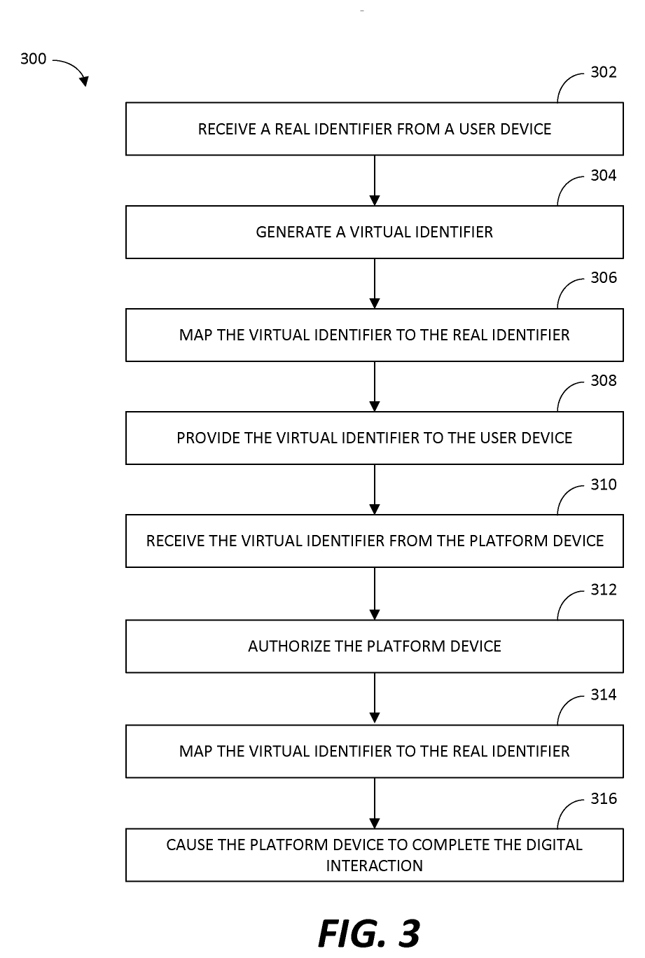

FIG. 2 is a sequence diagram 200 of the system 100 generating and utilizing a VMN, in accordance with one or more embodiments. The details of one or more of the following operations are discussed further below with regard to FIG. 3.

Operation 202 involves the user device 110 sending a request to the VMN device 140 to generate a new virtual identifier (e.g., virtual mobile number). This request may include the user’s real identifier and may also include metadata such as authentication credentials, user preferences, or specific requirements for the virtual identifier (e.g., format or expiration time). Upon receipt, the VMN device 140 validates the request to confirm that the request originates from an authorized user or application. The validation process may involve verifying the user’s authentication credentials, which may include tokens, digital certificates, or other cryptographically signed data, by cross-referencing them against a secure credential store. Credentials may be checked for validity, expiration, and/or revocation status, so that only users with current and approved credential can proceed.

In addition to credential verification, the VMN device 140 may maintain an audit log of credential usage and/or request history to support compliance and traceability. The VMN device 140 may also enforce rate-limiting policies by tracking the frequency and volume of requests associated with each credential and comparing these metrics to predefined thresholds to prevent abuse. The VMN device 140 may also enforce access control policies so that the request aligns with the permissions and/or roles assigned to the user or application, such as restrictions on the number of active virtual identifiers or the types of interactions permitted (e.g., for the user, for the virtual identifier). Once the request is validated, the VMN device 140 proceeds to the subsequent operation to generate the requested virtual identifier.

Operation 204 involves the VMN device 140 generating a virtual identifier. The generation process may involve querying a centralized directory (e.g., directory 142) to confirm that the virtual identifier is distinct and not already assigned to another user. The VMN device 140 may use a predefined algorithm to generate the virtual identifier so that the generated identifier conforms to a specific format, such as a 10-digit phone number. If the generated virtual identifier is found to be unavailable or already in use, the VMN device 140 may repeat the generation process until a distinct and available virtual identifier is created.

Operation 206 involves the VMN device 140 transmitting the newly generated virtual identifier to the user device 110.

Operation 208 involves the user device 110 sending the generated virtual identifier to another user device 120. This allows the user to utilize the virtual identifier for digital interactions, such as payments or communications, without exposing their real identifier.

Operation 210 involves the other user device 120 sending a request to the platform device 130 to perform a specific action, such as initiating a payment or communication. This request includes the virtual identifier and any additional information required to complete the action, such as the transaction amount or message content.

Operation 212 involves the platform device 130 sending a request to the VMN device 140 to resolve the virtual identifier of the user device 110 to the corresponding real identifier for processing the request of operation 210. The request of operation 212 includes the virtual identifier to be resolved and may also include metadata such as the authentication credentials of the platform device 130 and the context of the action being performed.

Operation 214 involves the VMN device 140 resolving the virtual identifier to the corresponding real identifier and sending the real identifier back to the platform device 130. This operation is performed after the platform device 130 has been successfully authorized in accordance with the access control policy (e.g., permission module 143) of the VMN device 140. The real identifier is transmitted over a secure channel to ensure confidentiality and is used for backend operations, such as transaction settlement or message delivery, without exposing the real identifier to unauthorized parties.

Operation 216 involves the platform device 130 sending a response to the user device 120, confirming the completion of the requested action. This response may include a confirmation of the action’s success, a transaction identifier, or any other relevant information. The response does not include the real identifier resolved in operation 214, ensuring that the privacy of the user device 110 is maintained throughout the digital interaction.

FIG. 3 is a flow diagram of an example process 300 for generating and resolving VMNs, in accordance with one or more embodiments. For explanatory purposes, FIG. 3 is described herein with reference to the system 100 of FIG. 1, and thus the process 300 may be a computer-implemented method. However, this is merely illustrative, and features of the system 100 may be performed by any other system for implementing the subject technology. Additionally, for explanatory purposes, the operations of the process 300 are described herein as occurring sequentially or linearly; however, multiple operations of the process 300 may occur in parallel. The operations of the process 300 need not be performed in the order shown, and one or more operations of the process 300 need not be performed or can be replaced by other operations.

Operation 302 involves the VMN device 140 receiving a first request for a virtual identifier from a user device 110, such as an application 111 running on the user device 110. The request may include a real identifier, such as the user’s real phone number, which may serve as the basis for generating the virtual identifier. The VMN device 140 may validate the request to confirm its authenticity and eligibility so that only authorized users/applications can access the virtual identifier generation functionality.

Operation 304 involves the VMN device 140 generating a virtual identifier in response to a validated request. During this operation, the VMN device 140 determines that the generated virtual identifier satisfies pre-determined conditions by conducting real-time availability checks against a centralized directory (e.g., directory 142). The pre-determined conditions may include being free of collisions, being unique, including certain characters, conformation to a pre-defined format. A pre-defined format may include a phone number, which in the US may be 10 digits, broken into a 3-digit area code, a 3-digit central office code, and a 4-digit line number. The VMN device 140 may perform these checks to confirm that the virtual identifier has not already been assigned to another user or is otherwise unavailable. If the pre-determined conditions are not satisfied, the VMN device 140 may automatically generate a new virtual identifier and repeat the verification process until the virtual identifier satisfies the pre-determined conditions.

In some embodiments, prior to generating the virtual identifier, the VMN device 140 may rate-limit the requesting device. The VMN device 140 may perform the rate limiting by comparing a rolling count of virtual identifier generation requests associated with the user device 110 to a predefined threshold and generating the virtual identifier in response to the first request when the predefined threshold is not exceeded.

Operation 306 involves the VMN device 140 mapping the generated virtual identifier to the corresponding real identifier, such as the user’s real phone number, and returning the virtual identifier to the requesting user or application. This mapping may be securely stored within a centralized directory (e.g., directory 142) so that the association between the virtual identifier and the real identifier remains confidential and protected from unauthorized access. By securely completing this mapping process, the VMN device 140 enables seamless use of the virtual identifier while safeguarding the user’s sensitive information.

Operation 308 involves the VMN device 140 providing the virtual identifier to the user device in response to the request from operation 302. The user device may then use the virtual identifier in one or more digital interactions with another user device in lieu of the real identifier.

Operation 310 involves the VMN device 140 receiving a second request from a platform device 130. The platform device 130 may facilitate interactions between a first user device (e.g., user device 110) and a second user device (e.g., user device 110). The platform device 130 may generate the second request in response to a request from the first user device and/or second user device to perform an interaction between the user devices. The second request may include the virtual identifier associated with the first user device.

Operation 312 involves the VMN device 140 authorizing the platform device 130. Authorization may include comparing the platform device 130 against an access control policy of the VMN device 140. The access control policy may define the criteria that must be satisfied for a platform device to be considered authorized. These criteria may include verifying the platform device’s identity through secure authentication mechanisms, such as digital certificates, API keys, and/or other cryptographic credentials. The VMN device 140 may also or instead check whether the platform device 130 is registered in a whitelist of approved platforms, whether it has a valid and current authorization token, and/or whether it complies with any requirements set by the system operator.

For example, the VMN device 140 receives the second request and extracts relevant identification and authentication information of the platform device 130 from the second request. The VMN device 140 then compares this information against the access control policy. If the credentials and attributes of the platform device 130 satisfy all policy requirements, the VMN device 140 marks the platform device 130 as authorized for the requested action. After the platform device 130 is successfully authorized, the VMN device 140 proceeds to resolve the virtual identifier to the real identifier or perform any further operations related to the digital interaction.

If the platform device 130 fails to meet the access control policy (e.g., due to invalid credentials, expired tokens, lack of registration, or any other non-compliance), the VMN device 140 may deny the request and prevent access to the mappings and/or any real identifiers.

Operation 314 involves the VMN device 140 mapping the virtual identifier to a real identifier, in response to determining that the platform device 130 is authorized. The VMN device 140 may access its directory 142, where active virtual identifiers and their associated real identifiers are securely stored. Using the virtual identifier supplied by the authorized platform device 130, the VMN device 140 locates the corresponding entry in the directory 142. The mapping may be one-to-one wherein each virtual identifier is uniquely associated with a single real identifier, which helps prevent ambiguity and ensures transaction integrity.

Once the VMN device 140 successfully retrieves the real identifier, it prepares the information for use in the backend processes of the digital interaction. The real identifier is not exposed to the platform device 130 in a way that would allow it to be shared with other users. Instead, the VMN device 140 ensures that the real identifier is used strictly for the purposes of completing the authorized interaction, such as payment settlement or account verification, while maintaining the privacy of the user. The VMN device 140 may maintain security controls including encryption of data in transit and at rest, audit logging of access events, and enforcement of data minimization principles.

Operation 316 involves the VMN device 140 causing the authorized platform device 130 to complete the digital interaction using the real identifier while withholding the real identifier from the second user device during the digital interaction. The VMN device 140 transmits the real identifier (e.g., the real phone number) to the authorized platform device 130 in a manner that ensures the real identifier is not exposed to the second user device or any other unauthorized party.

The platform device 130, now in possession of the real identifier, uses the real identifier for its processes required to complete the digital interaction. For instance, in a payment scenario, the platform device 130 may use the real phone number to settle the transaction with the financial institution or to trigger notifications to the user. However, the second user device, such as the device of the buyer or recipient in a transaction, continues to interact only with the virtual identifier and remains unaware of the real phone number or other sensitive information of the first user.

The VMN device 140 may enforce this separation through data handling policies. An example data handling policy includes not providing the real identifier in any communication sent to the second user device. User-facing interfaces, transaction records, notifications, and/or any other information visible to the second user device may reference only the virtual identifier. By orchestrating the transaction in this way, the VMN device 140 enables the platform device 130 to fulfill its operational requirements (e.g., verifying identities, settling payments, or delivering messages) while upholding the privacy guarantees of the system 100. The second user device is able to complete the interaction without ever gaining access to the real identifier, thereby minimizing the risk of identity theft, fraud, or unwanted contact.

In some embodiments, the VMN device 140 can resolve virtual identifiers for a variety of platform devices. For example, while the foregoing discussion of the process 300 was with respect to a first interaction between a first and second user devices facilitated by a first platform device, the first and second user devices may have one or more other interactions facilitated by one or more other platform devices in which the other platform devices provide a virtual identifier to the VMN device 140 to resolve. It should be understood that the process 300 is not limited by the number of interactions, number of user devices, or number of platform devices.

In some embodiments, prior to causing the authorized platform device 130 to complete the digital interaction using the real identifier, the VMN device 140 may rate limit requests from the platform device 130 to prevent abuse of the system. To rate limit requests, the VMN device 140 may maintain a rolling count of virtual identifier resolution requests associated with each platform device. The VMN device 140 may compare the count of requests associated with the platform device 130 to a predefined threshold. The VMN device 140 may provide the real identifier in response to the request from the platform device 130 when the predefined threshold is not exceeded. If the platform device 130 exceeds the predefined threshold, the VMN device 140 may deny the request and does not cause the platform device 130 to complete the digital interaction using the real identifier.

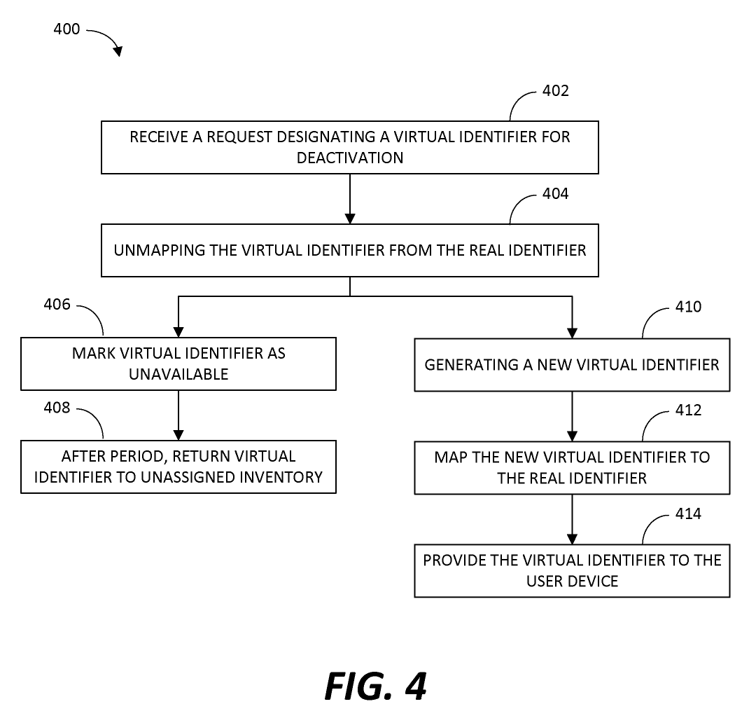

FIG. 4 is a flow diagram of an example process 400 for deactivating and/or updating VMNs, in accordance with one or more embodiments. For explanatory purposes, FIG. 4 is described herein with reference to the system 100 of FIG. 1, and thus the process 400 may be a computer-implemented method. However, this is merely illustrative, and features of the system 100 may be performed by any other system for implementing the subject technology. Additionally, for explanatory purposes, the operations of the process 400 are described herein as occurring sequentially or linearly; however, multiple operations of the process 400 may occur in parallel. The operations of the process 400 need not be performed in the order shown, and one or more operations of the process 400 need not be performed or can be replaced by other operations.

Operation 402 involves the VMN device 140 receiving, from the first user device, a request designating the virtual identifier for deactivation. In some embodiments, the request may be received in response to completion of the digital interaction with the second user device so that, e.g., the virtual identifier may be configured to be used on a per interaction basis. In some embodiments, the third request is received in response to the completion of a pre-determined time period so that, e.g., the virtual identifier may be configured to be used for a pre-determined period of time.

Operation 404 involves the VMN device 140 unmapping the virtual identifier from the real identifier. The VMN device 140 may remove the association between the virtual identifier and the real identifier in the centralized directory 142 so that the virtual identifier can no longer resolve to the real identifier. For example, if a user completes a transaction and no longer wants the virtual identifier to be active, the user can request deactivation through their app interface at operation

406. Alternatively, if the user requests a refresh, the VMN device 140 can unmap the current virtual identifier and generate a new virtual identifier at operation 410.

Operation 406 involves the VMN device 140 marking the virtual identifier as unavailable for re-mapping, such as during a configurable quarantine period. This may mean that, rather than immediately returning the virtual number to the pool of available numbers, the VMN device 140 places the virtual identifier in a deactivated state, preventing it from being reassigned to another user or mapped to a different real identifier until the quarantine period expires. For example, if a user deactivates their virtual identifier after an interaction, the VMN device 140 may enforce a 30-day quarantine to reduce the risk of fraud or confusion from recycled numbers. The quarantine period may be customized based on, e.g., risk factors, interaction type, and/or user preference, such as a shorter period for low-risk scenarios or a longer period for sensitive transactions.

Operation 408 involves the VMN device 140, after the expiration of the configurable quarantine period, returning the virtual identifier to an unassigned pool of identifiers so the virtual identifier may subsequently be re-mapped to another real identifier. When the system-determined or user-specified quarantine period has elapsed, during which the virtual identifier was held inactive to prevent immediate reuse, the VMN device 140 may update its directory 142 to mark the virtual identifier as available for re-mapping. For example, if a virtual identifier was quarantined for 30 days following deactivation, at the end of that period, the virtual identifier may be released back into the pool of available virtual identifiers and can be issued to a user requesting a new virtual identifier. Alternatively, the VMN device 140 may include dynamic quarantine durations based on factors such as transaction risk or user history, or to allow system administrators to manually review and release numbers for re-mapping.

Operation 410 involves the VMN device 140 generating a new virtual identifier in a manner similar to operation 304. For example, after a user completes a transaction and discards their old virtual identifier, the VMN device 140 may automatically generate and assign a new virtual identifier for subsequent use. In some embodiments, the VMN device 140 may enable users to schedule automatic virtual identifier refreshes at regular intervals, or provide options for users to select from a list of available virtual identifiers that are unique and unassigned at the time of generation.

Operation 412 involves the VMN device 140 storing a one-to-one mapping that associates the new virtual identifier with the real identifier in a manner similar to operation 306.

Operation 414 involves the VMN device 140 providing, in response to the request from operation 402, the second virtual identifier to the user device for use in a digital interaction with another user device in lieu of the user’s real identifier, which may be performed in a manner similar to operation 308.

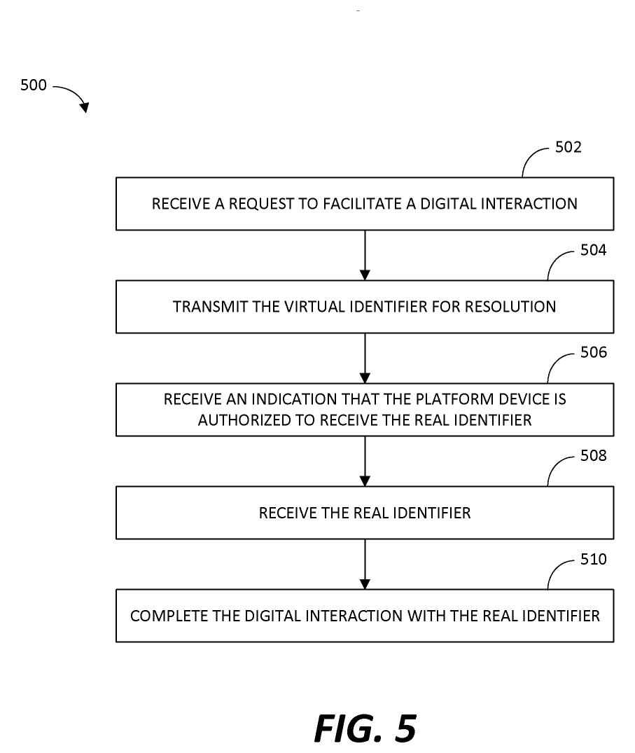

FIG. 5 is a flow diagram of an example process 500 for requesting and using virtual identifiers, in accordance with one or more embodiments. For explanatory purposes, the figure is described with reference to the system 100 of FIG. 1 and thus the process 500 may be a computer-implemented method. However, this is merely illustrative, and features of the system 100 may be performed by any other system for implementing the subject technology. Additionally, for explanatory purposes, the operations of the process 500 are described herein as occurring sequentially or linearly. However, multiple operations of the process 500 may occur in parallel. The operations of the process 500 need not be performed in the order shown, and one or more operations of the process 500 need not be performed or can be replaced by other operations.

Operation 502 involves the platform device 130 receiving a first request to facilitate a digital interaction between a first user device (e.g., user device 110) and a second user device (e.g., user device 110). The platform device 130 may be any hardware device and/or software application that intermediates and/or manages digital interactions, such as a payment service provider, messaging platform, or other online service that enables exchanges between users. The first request may be generated by the second user device, which may be operated by a user seeking to initiate a transaction, communication, or other interaction with the first user device.

The first request may include a virtual identifier that is associated with the first user device. This virtual identifier serves as a privacy preserving proxy for the real identifier of the first user. The inclusion of the virtual identifier in the request allows the platform device 130 to identify the intended recipient of the digital interaction without exposing the real identifier of the first user device to the second user device or to any other unauthorized party.

Operation 504 involves the platform device 130 transmitting, to the VMN device 140, a second request to resolve the virtual identifier to the corresponding real identifier. After receiving the first request from the second user device, which includes the virtual identifier associated with the first user device, the platform device 130 may prepare the second request (e.g., a resolution request) that is directed to the VMN device 140.

The platform device 130 may construct the second request by including the virtual identifier to be resolved. The second request may also contain additional metadata, such as the identity or authentication credentials of the platform device 130, an interaction identifier, a timestamp, and/or other information required by the access control policy of the VMN device 140. For example, if the platform device 130 is a payment service provider, the second request may include a unique transaction ID and the platform’s API key to authenticate the request. In another example, a messaging platform might include a session token or digital certificate to establish its authorization to perform the lookup.

Operation 506 involves the platform device 130 receiving an indication from the VMN device 140 regarding whether the platform device 130 is authorized to request resolution of the virtual identifier to the real identifier. Upon transmitting the second request, the platform device 130 awaits a response that communicates the outcome of the authorization check.

The VMN device 140 evaluates the information provided in the resolution request (e.g., API keys, digital certificates, session tokens, or other cryptographic credentials) against its access control policy. This policy may include requirements such as registration in a whitelist of approved entities, possession of a valid and current authorization token, compliance with regulatory or contractual obligations, and/or other criteria defined by the operator of VMN device 140. For example, a payment service provider may be required to present a signed certificate issued by a trusted authority, while a messaging platform might need to provide a time-limited OAuth token.

If the platform device 130 satisfies access control requirements, the VMN device 140 may return an indication of authorization and may continue with the process 500 of resolving the virtual identifier. The indication may take the form of a success status code (e.g., HTTP 200 OK), a signed authorization token, and/or a structured response message indicating that the platform device 130 is permitted to proceed with resolution. In some embodiments, the response may also include additional metadata, such as the scope of authorization, permitted actions, and/or expiration time of the authorization.

Alternatively, if the platform device 130 fails to meet the access control policy, the VMN device 140 returns an indication of denial and the process 500 does not proceed to operation 508. The indication may take the form of an error status code (e.g., HTTP 403 Forbidden), a structured error message, a specific denial reason, and/or a structured response message indicating that the platform device 130 is not permitted to proceed with resolution. In some embodiments, when authorization is denied, the platform device 130 may facilitate the digital interaction using the virtual identifier itself, rather than the resolved real identifier. For example, in a messaging context, the platform device 130 may allow the second user device to send a message to the virtual identifier, with the expectation that the message will be routed or proxied by the VMN device 140 without revealing the underlying real identifier. In a payment context, the platform device 130 may allow the transaction to proceed using the virtual identifier as the recipient identifier, deferring or omitting the resolution step.

Operation 508 involves the platform device 130, in response to receiving an indication of authorization, receiving from the VMN device 140 the real identifier that is mapped to the virtual identifier. Once the platform device 130 has been successfully authorized by the VMN device 140, the VMN device 140 transmits the real identifier associated with the provided virtual identifier. This enables the platform device 130 to proceed with its backend processes that utilize the real identifier, such as payment settlement, account verification, or secure delivery of information.

The transmission of the real identifier may occur over a secure channel for the confidentiality and integrity of the sensitive data. For example, the VMN device 140 may respond to the platform device’s API call with a JSON payload containing the resolved real identifier, along with any relevant metadata such as a transaction ID, timestamp, and/or expiration indicator. In some implementations, the response may also include a digital signature or cryptographic proof to verify the authenticity and integrity of the mapping.

In some embodiments, the VMN device 140 may enforce additional safeguards before providing the real identifier. For instance, the VMN device 140 may check whether the virtual identifier is still active or has been deactivated. Deactivation may occur after the expiration of a configurable quarantine period or upon explicit request from the first user device. If the virtual identifier has been deactivated, the VMN device 140 may return an error message or a status code indicating that the mapping is no longer valid, preventing the release of the real identifier.

In some embodiments, the VMN device 140 may implement rate-limiting mechanisms to prevent abuse such as excessive resolution requests. Before transmitting the real identifier, the VMN device 140 may determine whether a rolling count of virtual identifier resolution requests associated with the second user device and/or the platform device 130 exceeds a predefined threshold. For example, if a particular second user device and/or platform device has made an unusually high number of resolution requests within a specified time window, the VMN device 140 may deny the request and return a rate-limit error or other error message indicating that the threshold has been exceeded.

In some embodiments, the VMN device 140 may provide partial information or require additional authentication steps if certain risk factors are detected. For example, if the request volume is approaching the threshold, the VMN device 140 may prompt multi-factor authentication or require manual review before releasing the real identifier.

Operation 510 involves the platform device 130, in response to the first request, facilitating a digital interaction using the real identifier while withholding the real identifier from the second user device. After the platform device 130 has received the real identifier mapped to the virtual identifier from the VMN device 140, the platform device 130 utilizes the real identifier for backend processes to facilitate the digital interaction, such as payment settlement, account verification, or secure delivery of notifications.

For example, in a payment scenario, the platform device may use the real phone number to initiate a funds transfer with a financial institution, trigger a payment confirmation SMS, or update internal records, all without exposing the real identifier to the second user device. The second user device continues to interact with the platform using only the virtual identifier as the recipient or contact identifier. Any user-facing interfaces, transaction records, or notifications visible to the second user device reference only the virtual identifier so that the real identifier remains confidential.

In a messaging scenario, the platform device 130 may route messages or notifications to the real identifier for delivery, but the sender (the second user device) may only be aware of the virtual identifier. The platform device 130 may act as a proxy, relaying communications between the two parties while maintaining the privacy of the first user’s real identifier. This approach can be extended to other types of digital interactions, such as account recovery, two-factor authentication, or service enrollment, where the real identifier is utilized for backend processing but should not be disclosed to the initiating party.

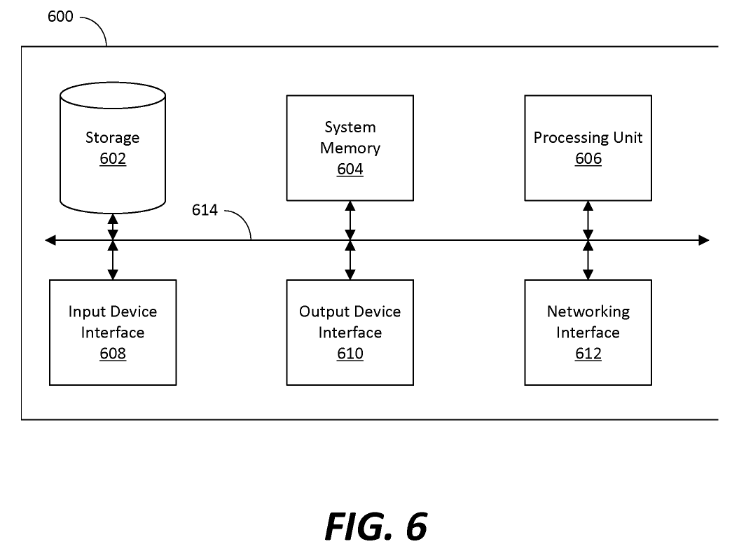

FIG. 6 is a block diagram of an example computing system 600 with which aspects of the present disclosure may be implemented. The computing system 600 may be, and/or may be part of, any electronic device for generating the features and processes described in reference to the foregoing figures, including but not limited to a desktop computer, server computer, tablet computer, smartphone, and wearable device (e.g., smartwatch, fitness band). The computing system 600 may include various types of computer-readable media and interfaces for various other types of computer-readable media. The computing system 600 includes a processing unit 606,

persistent storage device 602, system memory 604, input device interface 608, output device interface 610, bus 614, and/or network interface 612.

The bus 614 collectively represents all system, peripheral, and chipset buses that communicatively connect the numerous internal components of the computing system 600. In one or more embodiments, the bus 614 communicatively couples the processing unit 606 with the system memory 604 and/or the persistent storage device 602. From these various memory units, the processing unit 606 retrieves instructions to execute and data to process in order to execute the processes of the subject disclosure. The processing unit 606 can be one or more processors, each of which can be a single- or multi-core processor.

The persistent storage device 602 may be a non-volatile memory unit that stores instructions and data. The persistent storage device 602 may be or include a mass-storage device (e.g., a magnetic or optical disk and its corresponding disk drive). In some embodiments, a removable storage device (e.g., a floppy disk, flash drive, and its corresponding disk drive) may be used as the persistent storage device 602.

The system memory 604 may be a volatile read-and-write memory, such as RAM. The system memory 604 may store any of the instructions and data that the processing unit 606 may need at runtime. In some embodiments, the processes of the present disclosure are stored in the system memory 604 and/or the persistent storage device 602. From these various memory units, the processing unit 606 retrieves instructions to execute and data to process in order to execute the processes of one or more implementations.

The bus 614 also connects to the input device interface 608 and output device interface 610. The input device interface 608 enables a user to communicate information and send commands to the computing system 600. Input devices that may be used with the input device

interface 608 may include, for example, keyboards, touch screens, and pointing devices. The output device interface 610 may enable, for example, the display of text and/or images generated by computing system 600. Output devices that may be used with the output device interface 610 may include, for example, printers and display devices, such as a liquid crystal display (LCD), a light emitting diode (LED) display, an organic light emitting diode (OLED) display, a flexible display, a flat panel display, a projector, or any other device for outputting information.

One or more embodiments may include devices that function as both input and output devices, such as a touchscreen. Feedback provided to the user can be any form of sensory feedback, such as visual feedback, auditory feedback, or tactile feedback. Input from the user may be received in any form, including acoustic, speech, or tactile input.

The bus 614 also couples the computing system 600 to one or more networks and/or to one or more network nodes through the network interface 612. In this manner, the computing system 600 can be a part of a network of computers (such as a local area network (LAN), a wide area network (WAN), or an intranet, or a network of networks, such as the internet). Any or all components of the computing system 600 can be used in conjunction with the present disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be a non-transitory computer-readable medium.

The computer-readable storage medium can be any storage medium that can be read, written, or otherwise accessed by a general purpose or special purpose computing system, including any processing electronics and/or processing circuitry capable of executing instructions. For example, without limitation, the computer-readable medium can include any volatile

semiconductor memory, such as RAM (Random Access Memory), DRAM (Dynamic RAM), SRAM (Static RAM), and Z-RAM (Zero-Capacitor RAM). The computer-readable medium also can include any non-volatile semiconductor memory, such as ROM (Read-Only Memory), PROM (Programmable ROM), EPROM (Erasable Programmable ROM), EEPROM (Electrically Erasable Programmable ROM), NVRAM (Non-Volatile RAM), and flash memory.

Further, the computer-readable storage medium can include any non-semiconductor memory, such as optical disk storage, magnetic disk storage, magnetic tape, other magnetic storage devices, or any other medium capable of storing machine-readable instructions. In one or more implementations, the tangible computer-readable storage medium can be directly coupled to a computing system, while in other implementations, the tangible computer-readable storage medium can be indirectly coupled to a computing system, e.g., via one or more wired and/or wireless connections.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled persons may implement the described functionality in varying ways for each particular application. Various components and blocks may be arranged differently (e.g., arranged in a different order, or partitioned in a different way) all without departing from the scope of the present disclosure.

While this disclosure has described certain embodiments, it is understood that the claims are not intended to be limited to these embodiments except as explicitly recited in the claims. On the contrary, the present disclosure is intended to cover alternatives, modifications, and equivalents, which may be included within the spirit and scope of the disclosure. Furthermore, in the detailed description of the present disclosure, numerous specific details are set forth in order to provide a thorough understanding of the disclosed embodiments. However, the present disclosure is not limited to the specific details set forth herein and can be practiced using one or more other embodiments. In other instances, well known methods, procedures, components, and circuits have not been described in detail as not to unnecessarily obscure various aspects of the present disclosure. Additionally, in one or more embodiments, structures and components are shown in block diagram form to avoid obscuring the concepts of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing system. For reasons of convenience, and with reference to common usage, such data is referred to as bits, values, elements, symbols, characters, terms, numbers, or the like, with reference to various presently disclosed embodiments. It is understood, however, that these terms are to be interpreted as referencing physical manipulations and quantities and are merely convenient labels that should be interpreted further in view of terms commonly used in the art.

Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing system, that manipulates and transforms data. The data is represented as physical (electronic) quantities within the computer system’s registers and memories and is transformed into other data similarly represented as physical quantities within the computer system memories or registers, or other such information storage, transmission, or display devices as described herein or otherwise understood to one of ordinary skill in the art.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together into a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of any of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Headings and subheadings, if any, are used for convenience only and do not limit the subject disclosure.

What is claimed is:

1. A method for facilitating privacy preserving digital interactions, the method comprising:
receiving, by a virtual identifier directory device, a first request from a first user device, the first request including a real identifier associated with the first user device;
generating, by the virtual identifier directory device, a virtual identifier that conforms to a pre-defined format and is unique from virtual identifiers mapped to real identifiers in the virtual identifier directory device;
storing, at the virtual identifier directory device, a one-to-one mapping that associates the virtual identifier with the real identifier;
providing, in response to the first request, the virtual identifier to the first user device for use in a digital interaction with a second user device in lieu of the real identifier;
receiving, by the virtual identifier directory device and from a platform device facilitating the digital interaction, a second request, the second request comprising the virtual identifier associated with the first user device;
authorizing the platform device against an access control policy of the virtual identifier directory device;
mapping the virtual identifier to the real identifier, in response to determining that the platform device is authorized; and
causing the authorized platform device to complete the digital interaction using the real identifier while withholding the real identifier from the second user device during the digital interaction.

2. The method of claim 1, wherein the platform device is a first platform device and the digital interaction is a first digital interaction, and further comprising:
receiving, by the virtual identifier directory device and from a second platform device facilitating a second digital interaction, a third request, the third request comprising the virtual identifier associated with the first user device;
authorizing the second platform device against the access control policy of the virtual identifier directory device;
mapping the virtual identifier to the real identifier, in response to determining that the second platform device is authorized; and
causing the second platform device to complete the second digital interaction with a third user device using the real identifier while withholding the real identifier from the third user device during the digital interaction.

3. The method of claim 1, further comprising:
receiving, from the first user device, a third request designating the virtual identifier for deactivation; and
unmapping the virtual identifier from the real identifier.

4. The method of claim 3, wherein unmapping the virtual identifier from the real identifier comprises:
marking the virtual identifier as unavailable for re-mapping during a configurable quarantine period; and
after expiration of the configurable quarantine period, returning the virtual identifier to an unassigned pool for potential re-mapping to another real identifier.

5. The method of claim 3, wherein the virtual identifier is a first virtual identifier, and further comprising:
generating, by the virtual identifier directory device, a second virtual identifier that conforms to the pre-defined format, is unique from virtual identifiers mapped to real identifiers in the virtual identifier directory device;
storing, at the virtual identifier directory device, a one-to-one mapping that associates the second virtual identifier with the real identifier; and
providing, in response to the third request, the second virtual identifier to the first user device for use in a digital interaction with the second user device in lieu of the real identifier.

6. The method of claim 3, wherein the third request is received in response to completion of the digital interaction.

7. The method of claim 3, wherein the third request is received in response to completion of a pre-determined time period.

8. The method of claim 1, further comprising, prior to generating the virtual identifier, rate-limiting the first request by comparing a rolling count of virtual identifier generation requests associated with the first user device to a predefined threshold and generating the virtual identifier in response to the first request when the predefined threshold is not exceeded.

9. The method of claim 1, further comprising, prior to causing the authorized platform device to complete the digital interaction using the real identifier, rate-limiting the second request by comparing a rolling count of virtual identifier resolution requests associated with the platform device to a predefined threshold and providing the real identifier in response to the second request when the predefined threshold is not exceeded.

10. A virtual identifier directory device comprising:
a processor; and
a non-transitory computer-readable medium storing instructions that, when executed by the processor, cause the virtual identifier directory device to perform operations comprising:
in response to a first request from a first user device, providing, by the virtual identifier directory device, a virtual identifier for use in a digital interaction with a second user device as proxy for a real identifier, wherein the first request includes the real identifier associated with the first user device, the virtual identifier conforms to a pre-defined format, and the virtual identifier directory device includes a mapping between the virtual identifier and the real identifier; and
in response to a second request from an authorized platform device facilitating the digital interaction, providing the real identifier to the authorized platform device causing the authorized platform device to complete the digital interaction using the real identifier while withholding the real identifier from the second user device during the digital interaction, wherein the second request includes the virtual identifier.

11. The virtual identifier directory device of claim 10, wherein the operations further comprise:
prior to providing the real identifier to the platform device, authorizing the platform device against an access control policy of the virtual identifier directory device; and
in response to determining that the platform device is authorized, generating the mapping between the virtual identifier and the real identifier.

12. The virtual identifier directory device of claim 10, wherein the operations further comprise:
in response to a third request from the first user device, deleting the mapping between the virtual identifier and the real identifier, wherein the third request designates the virtual identifier for deactivation, and the virtual identifier cannot be re-mapped to another real identifier for a pre-determined period of time.

13. The virtual identifier directory device of claim 12, wherein the virtual identifier is a first virtual identifier, and further comprising:
in response to a third request from the first user device, providing a second virtual identifier for use in another digital interaction with the second user device in lieu of the real identifier, wherein the third request includes the real identifier associated with the first user device, the second virtual identifier conforms to the pre-defined format, and the virtual identifier directory device includes a mapping between the second virtual identifier and the real identifier.

14. The virtual identifier directory device of claim 12, wherein the third request is received in response to completion of the digital interaction.

15. The virtual identifier directory device of claim 12, wherein the third request is received in response to completion of a pre-determined time period.

16. A method comprising:
receiving, by a platform device, a first request to facilitate a digital interaction between a first user device and a second user device, where in the first request includes a virtual identifier associated with a first user device, and the first request is from the second user device;
transmitting, by the platform device and to a virtual identifier directory device, a second request to resolve the virtual identifier to a real identifier;
receiving, by the platform device, an indication that the platform device is authorized to request resolution according to an access control policy of the virtual identifier directory device;
in response to receiving an indication of authorization, receiving, by the platform device and from the virtual identifier directory device, the real identifier mapped to the virtual identifier; and
in response to the first request, completing, by the platform device, a digital interaction using the real identifier while withholding the real identifier from the second user device during the digital interaction.

17. The method of claim 16, wherein the virtual identifier is deactivated after one or more of an expiration of a configurable quarantine period or the first user device requests deactivation.

18. The method of claim 16, wherein the real identifier is received in response to a determination that a rolling count of virtual identifier resolution requests associated with the second user device does not exceed a predefined threshold.

19. The method of claim 16, wherein the real identifier is received in response to a determination that a rolling count of virtual identifier resolution requests associated with the platform device does not exceed a predefined threshold.

20. The method of claim 16, further comprising:
when the platform device lacks authorization to resolve the virtual identifier, facilitating the digital interaction using the virtual identifier.
